(19) United States
(12) Patent Application Publication
(10) Pub. No.: US 2002/0152250 A1
(43) Pub. Date: Oct. 17, 2002

(54) FINITE-IMPULSE-RESPONSE (FIR) FILTER EMPLOYING A PARALLEL ARCHITECTURE

(76) Inventor: ROBERT B. STASZEWSKI, GARLAND, TX (US)

Correspondence Address: TEXAS INSTRUMENTS INCORPORATED, P O BOX 655474, M/S 3999, DALLAS, TX, 75265

(21) Appl. No.: 09/256,568

(22) Filed: Feb. 24, 1999

(51) Int. Cl. G06F 17/10

(52) U.S. Cl. 708/319; 708/300; 708/408

(57) ABSTRACT

A system and a method for signal processing by employing parallel paths (107 and 110) for processing separate parts of the signal. The method effectively doubles operating speed by providing at least two processing paths. Where two paths are used, each operates at approximately one-half of the data rate of the incoming data signal. By using parallel paths to process signals through a FIR filter (100), for example, the method can take full advantage of a high order encoding system, such as Radix-8. Further, because of relaxed clock speeds, a preferred embodiment allows use of smaller and faster latches (103), instead of flip-flops, for the retiming stages. Finally, when used with a FIR filter (100), the method makes use of the normal irregularity of critical path delays at various stages by borrowing retiming slacks from less time-critical taps (101) of the FIR filter (100).

### FIELD OF THE INVENTION

The present invention relates to a system and a method for increasing throughput rate of a signal processor, for example, one that uses a finite-impulse-response (FIR) filter. In particular, it provides a system a for parallel processing of a digital signal encoded in Radix-N.

### BACKGROUND

A FIR filter may be included in the general class of devices referred to as digital signal processors (DSP). This does not mean that the FIR can operate only on digital signals, however.

A “digital signal” is a signal that conveys a discrete number of values at discrete times. Contrast the “analog signal,” i.e., a signal that conveys an infinite number of values whether continuous time or discrete time. A signal having a digital form may be generated from an analog signal through sampling and quantizing the analog signal. Sampling an analog signal refers to “chopping” the signal into discrete time periods and capturing an amplitude value from the signal in selected ones of those periods. The captured value becomes the value of the digital signal during that sample period. Such a captured value is referred to as a sample.

Quantizing refers to approximating a sample with a value that may be represented on a like digital signal. For example, a sample may lie between two values characterized upon the digital signal. The value nearest (in absolute value) to the sample may be used to represent the sample. Alternatively, the sample may be represented by the lower of the two values between which the sample lies. After quantization, a sample from an analog signal may be conveyed as a digital signal. This is the resultant signal upon which the FIR filter may operate.

A DSP transforms an input digital signal to an output digital signal. For the digital FIR filter, the transformation involves filtering out undesired portions of the received digital signal. An original analog signal may be represented as a sum of a plurality of sinusoids. Each sinusoid oscillates at a particular and unique frequency. Filtering is used to remove certain frequencies from an input signal while leaving other frequencies intact.

A FIR filter is a device in which an input sample produces a finite number of output samples. After the finite number of samples expires, the FIR filter output is no longer affected by that particular input sample. Transversal filters, of which FIR filters may be a class, are filters in which a certain number of past samples are used along with the current sample to create each output sample.

Programs executing on a FIR filter are real-time programs in that the instructions are manipulating a sample of a digital signal during the interval preceding the receipt of the next sample. If the program cannot complete manipulating a sample before the next sample is provided, then the program will eventually begin to “lose” samples. A lost sample does not get processed, and therefore the output signal of the FIR filter no longer contains all of the information from the input signal provided to the FIR filter. This potential for losing samples is reduced by a preferred embodiment of the present invention, while maintaining a required throughput rate.

Besides considering a FIR filter's throughput, all design parameters have an associated cost. One important cost factor is the silicon area needed to “house” the FIR filter. Those that are manufactured on a relatively small silicon chip are less expensive than those requiring a large chip. Therefore, an easily manufacturable, small (low cost) FIR filter is desirable.

Some features of FIR filters that are important to the design engineer include phase characteristics, stability (although FIR filters are inherently stable), and coefficient quantization effects. To be addressed by the designer are concerns dealing with finite word length and filter performance. When compared with other filter options such as infinite impulse response (IIR) filters, only FIR filters have the capability of providing a linear phase response and are inherently stable, i.e., the output of a FIR filter is a weighted finite sum of previous inputs. Additionally, the FIR filter uses a much lower order than a generic Nyquist filter to implement the required shape factor. FIR filters are subject to non-negligible inter-symbol interference (ISI), however.

Coefficient quantization error occurs as a result of the need to approximate the ideal coefficient for the “finite precision” processors used in real systems. The result of coefficients being approximated is a deviation from ideal in the frequency response.

Quantization error sources due to finite word length include:

a) input/output (I/O) quantization,

b) filter coefficient quantization,

c) uncorrelated roundoff (truncation) noise,

d) correlated roundoff (truncation) noise, and

e) dynamic range constraints.

Input noise associated with the analog-to-digital (A/D) conversion of continuous time input signals to discrete digital form and output noise associated with digital-to-analog conversion are inevitable in digital filters. Propagation of this noise is not inevitable, however.

Uncorrelated roundoff errors most often occur as a result of multiplication errors. For example, in attempting to maintain accuracy for signals that are multiplied, only a finite length can be stored and the remainder is truncated, resulting in “multiplication” noise being propagated. Obviously, any method that minimizes the number of multiplication steps will also reduce noise and increase inherent accuracy.

Correlated roundoff noise occurs when the products formed within a digital filter are truncated. These include the class of “overflow oscillations.” Overflows are caused by additions resulting in large amplitude oscillations. Correlated roundoff also causes “limit-cycle effect” or small-amplitude oscillations. For systems with adequate coefficient word length and dynamic range, this latter problem is negligible. However, both overflow and limit-cycle effects force the digital filter into non-linear operation.

A typical example of a high-speed FIR with five or more coefficients is a Type II FIR. A Type II FIR is based on an array of costly Multiply and Add (MAC) accumulation stages. A conventional system using MAC is constrained to a minimum number of gates to achieve a given partial product accuracy. Digital implementation of an FIR filter is also limited by the maximum number of logic gates that can be inserted between reclocking stages established by the filter's clock cycle. Thus, for a given digital process, a minimum time to process is established by the propagation time through the critical path. To achieve very high speeds of processing, the critical path is broken into a number of shorter paths that can be addressed at higher clock speeds, i.e., processed within a short clock cycle. A preferred embodiment of the present invention implements an alternative using parallel processing of an interleaved signal.

Some conventional high-speed systems employing FIR filters use an analog FIR filter placed before an analog-to-digital converter (ADC). This prevents the FIR filter's latency from accumulating in the sampled timing recovery loop. This method is inherently not well suited to digitally intensive designs.

Some existing designs always include the FIR filter in the timing recovery loop, increasing latency ab initio, and decreasing stability of the embedded loops, both the timing recovery and gain loops, for example.

Other designs bypass the FIR filter during acquisition but require the coefficients of the FIR filter to be symmetric in order to avoid a phase hit when switching back the FIR filter at the end of the acquisition period.

In magneto-resistive (MR) heads using FIR filters, with their inherent response nonlinearities, this constraint is becoming even more unacceptable. There are more modern methods that achieve a fully digital solution, but these are extremely complex while covering a disproportionately large area on a silicon chip. In one design, discrete time analog values are entered in memory as are weights, some of which are set to zero to improve throughput. In this architecture neither pass through delay lines.

There have been several novel approaches to achieving performance improvement of FIR filters. One involves converting a digital signal to log values, thus avoiding the use of multipliers. A second more traditional technique uses oversampling. Yet another approach uses variations of multiplexing, i.e., a multiplexed data stream is input to a tapped delay line and the filter provides a multiplexed output of alternated samples.

For those data streams that have a high dynamic range, a method involving splitting the sampled input signal into two portions and addressing each separately in separate filters has been proposed. Of course, this doubles the number of operations and the hardware required.

Some of the above introduce additional complexity not required in the preferred embodiments of the present invention while others may not be suitable for high-speed applications.

In a magnetic disk data storage system, for example, information is recorded by inducing a pattern of magnetic variations on the disk, thus encoding the information. The magnetic variations are recorded along concentric circular tracks on the disk. The linear density with which the magnetic flux changes may be recorded along a track as well as the radial density of tracks on the disk is ever increasing.

As the recording density is increased, however, the magnetic readback signal from the disk becomes more and more difficult to read and interpret due in part to inter-symbol interference (ISI). ISI results from process-time overlaps and the reduced spacing between neighboring magnetic flux patterns along an individual track as well as between those on adjacent tracks. For drives with interchangeable disks, in particular, each disk may introduce its own irregularities into the readback signal due to naturally occurring variations within manufacturing tolerances. Moreover, the irregularities are not uniform even over an individual disk, but depend to some degree on radial position.

Increased data density has prompted the use of digital signal processing techniques to extract data from noisy, distorted or otherwise irregular readback signals. In one commonly used technique, a sequence of consecutive raw data samples read from the disk is passed through a filter that continuously monitors the expected error in the signal and corrects data accordingly. A popular class for this purpose comprises the adaptive FIR filters.

These filters provide time-varying signal processing that adapts signal characteristics, in real time, to a sensed error measure. The characteristics are defined by time-varying coefficients, the values of which are adjusted at regular intervals, again in real time, in order to minimize cumulative error.

An adaptive FIR filter may be thought of as having two parts: a filter structure that uses coefficients to modify data, and an adaptation circuit that updates the values of the coefficients. Existing implementations of filter structures and adaptation circuits are subject to design compromises.

The dynamic power dissipated in conventional filter circuit implementations (assuming the use of CMOS ICs) is given by the relationship:

Pα∝C×V²×f×N_{Gate} (2)

where:

C=the average loading capacitance of a gate in the IC chip,

V=the power supply voltage level,

f=the operating frequency, and

N_{gate}=the number of gates that are switching at frequency, f.

Improved performance is generally realized with a higher operating frequency, f, but comes at the expense of higher power dissipation levels.

From Eqn. (2), power consumption also increases in proportion to the number of gates. A common IC embodiment of FIR filters is a tapped delay line, in which each of the coefficients characterizing the filter corresponds to a separate “tap” along a delay line. The number of gates goes up in proportion to the number of taps. The number of taps dictates the overall time delay for data (in Type I FIR structure) to pass through the filter and thus limits the operating frequency (data rate). To compensate for this delay, data pipelining is introduced to increase the FIR filter's operating frequency and the effective system throughput. However, pipelining calls for more gates, resulting in even greater power consumption.

In addition to the power demand, conventional FIR filter coefficient adaptation circuits can introduce a bottleneck. To provide updated filter coefficients in successive clock cycles as new data are latched through, conventional adaptation circuits require computations to be performed within a single clock cycle. This makes it difficult to increase the overall speed of the data detection system as a whole and limits the circuitry and algorithms that may be employed for updates.

Existing filter adaptation circuits also experience updated coefficients that wander from optimal when the coefficient adaptation process is operated simultaneously with a “decision-directed” timing recovery loop. This prevents consistent convergence to optimal values and impedes the performance.

A “pipelining” method is normally used to achieve better FIR performance at high input data rates. The cost of using this method is increased latency, however. At very high speeds, such as are being seen with newer systems, conventional pipelining falls subject to the law of diminishing returns. The pipelining “overhead” now consumes a larger percentage of the benefits gained from higher clock speeds. The overhead consists of a required latching or reclocking stage for every pipelining command. Generally, the performance improvement for one level of pipelining is less than two while the hardware cost increase is greater than two. All the while this is occurring at the very high clock rate of the input data. A preferred embodiment of the present invention addresses this clock rate limitation.

### SUMMARY

A preferred embodiment of the present invention provides a system and method for increasing the speed of operation of FIR filters by “parallelizing” operation of the filter. By providing parallel paths for operation, without increasing hardware, in conjunction with adopting a high order Radix-N number encoding system, such as Radix-8, for encoding input data, the operations speed is doubled.

By having each path of the parallel operation operate at half the input data rate, taking advantage of the slack time borrowing at less critical taps of the FIR filter during retiming, and providing for certain operations to be made common to each path, required silicon area on the chip is also significantly reduced.

This is accomplished by de-interleaving the digitized input signal to the FIR filter proper and making available two paths for processing a single signal. See FIG. 1 for an example of a 5-tap FIR filter 100 in a preferred embodiment of the present invention. Data stream “samples” of the input signal DTI are provided to separate buses 107 and 110 in FIG. 1a. For sake of easy identification the signal is said to be split into “odd” bits, processed on bus 110, and “even” bits processed on bus 107. If a higher order numbering system is used the encoder could be Radix-4, or preferably, Radix-8.

FIR filter coefficients 105 of FIG. 1a are supplied to both paths from a memory device (not shown). A clock signal (not shown) is provided from a timing recovery loop (not shown) to insure that the “samples” are being taken at the appropriate instance. A processing period of 2T, where T is the clock rate of input data signal DTI, is made available by processing odd bits on the “rising edge” of the clock signal at delay lines 103 along bus 110 and 110a. Of course, the opposite is the case for the even bits processed on the “falling edge” of the clock signal at delay lines 103 along buses 107 and 107a. In a preferred embodiment of the present invention the delay lines 103 can be configured using simple latches (not shown) and incorporate a multiply and accumulate (MAC) function for each tap 101. This alternating processing of even and odd bits on two different buses and at opposite levels of a clock signal provides the 2T processing period that differentiates a preferred embodiment of the present invention from existing designs, including those using separate FIR filters to accomplish the same end.

Some of the salient advantages of the present invention are that it:

significantly increases throughput.

reduces required silicon area on the chip, considering the performance improvement.

reduces overhead.

reduces latency.

reduces fabrication cost.

uses simpler, more reliable components.

uses a clock speed that is half the input data rate.

facilitates borrowing of the slack time at non-critical taps.

makes selected operations common to each path.

applicable to both adaptive and fixed FIR filters.

### BRIEF DESCRIPTION OF DRAWINGS

FIG. 1a is a block diagram of the preferred embodiment employing a 5-tap FIR filter showing the optional input stream de-interleaver.

FIG. 1b depicts a timing sequence of processing at a series of taps for an 5-tap FIR filter of a preferred embodiment of the present invention.

FIG. 2 is a diagram of a representative parallel layout of a preferred embodiment employing a 5-tap FIR filter showing the optional input stream de-interleaver, Radix-N encoder, and output stream re-interleaver.

FIG. 3 is a block diagram similar to FIG. 1 for a preferred embodiment of the present invention using an even number of taps (8) in the FIR filter.

FIG. 4 is a detailed block diagram of the last tap of the FIR filter used in FIG. 1 with an option of the programmable reduction of the filter length by two taps.

FIG. 5a depicts processing, coupled with use of the Radix-8 numbering system, at a single tap of a FIR filter employed in a preferred embodiment of the present invention

FIG. 5b depicts timing, interleaving, and processing times, as well as slack times for the single tap of FIG. 5a.

FIG. 6a depicts timing sequence of a middle tap of a 5-tap FIR filter of a preferred embodiment of the present invention.

FIG. 6b depicts timing sequences for parallel processing of even and odd bit streams for the middle tap of the 5-tap FIR filter of FIG. 6a.

FIG. 7 depicts timing sequences for parallel processing of even and odd bit streams in a 5-tap FIR filter employed in a preferred embodiment of the present invention.

FIG. 8 depicts the efficient rectangular layout available for chip layout of an 8-tap embodiment of the present invention.

FIG. 9 provides a sample timing sequence as in FIG.7, but using four-way processing of parallel circuits.

### DETAILED DESCRIPTION OF THE PREFERRED EMBODIMENTS

The class of FIR filters with k coefficients fulfills the relationship:

$$Y ( n ) = {\sum }_{j = 0}^{k - 1} C ( f ) \times X ( n - j ) \qquad ( 3 )$$

Where:

C(j)=coefficient of the filter with X(n) as an input sample and Y(n) as an output sample

Y(n)=sum of the products over the interval, j=0 . . . k−1

j=the index

X(n)=the most recent value of the input sample

X(n−j)=the delayed sample value associated with delay, j

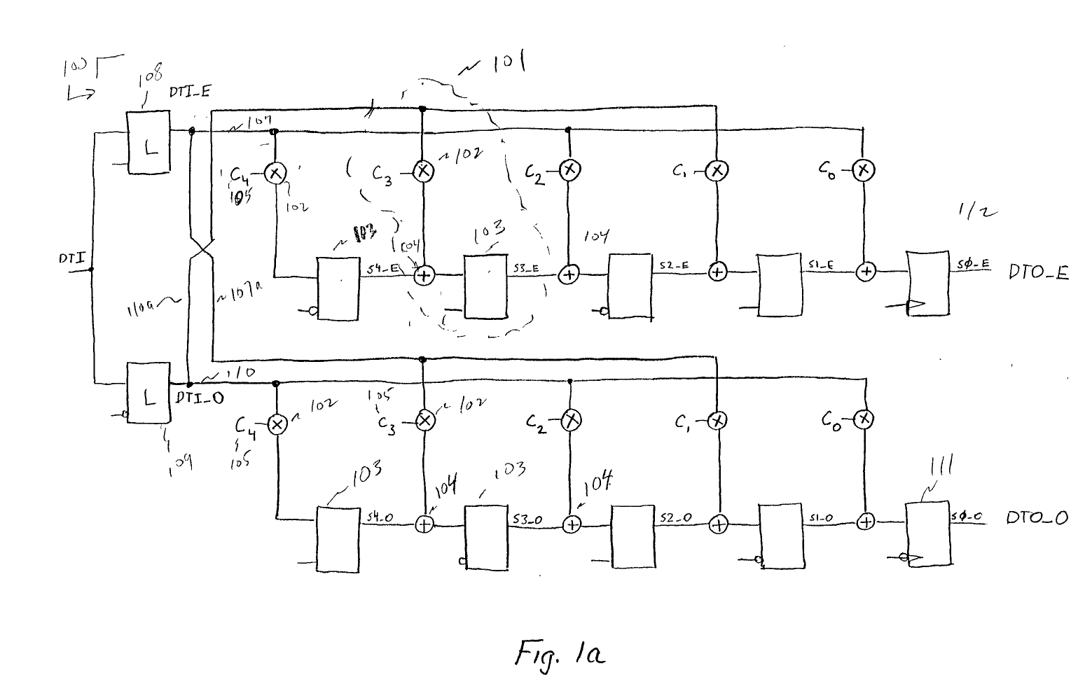

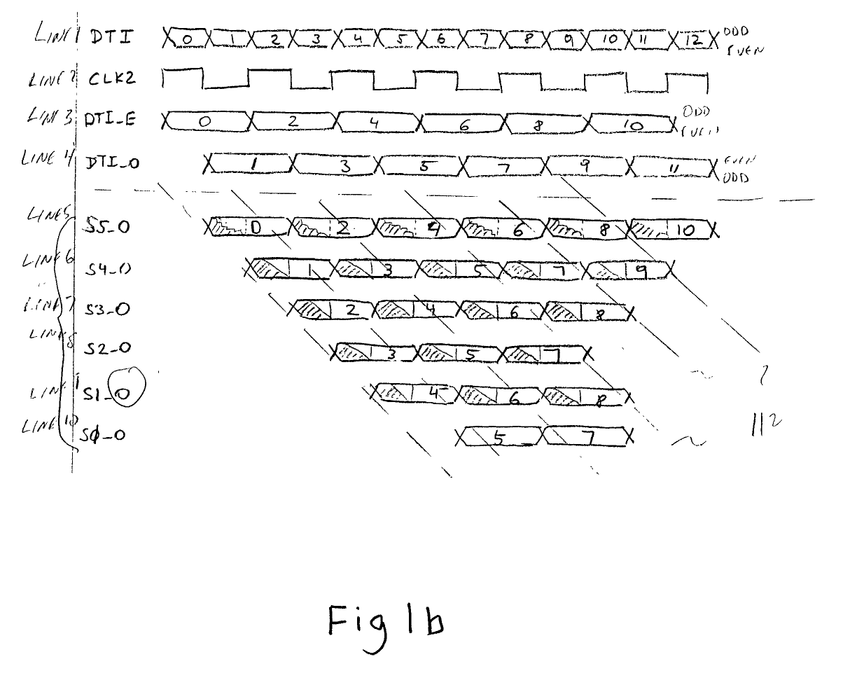

FIG. 1a shows a preferred embodiment of the FIR filter 100 that includes five taps, tap no. 3 shown as 101, with Multiply-and-Accumulate operations carried out at each tap as shown for tap no. 3 101. A coefficient C₃ 105, provided from an external memory (not shown), is multiplied with even bits of the 6-bit input signal (or its encoded representation) provided on buses 107 and 107a from de-interleaver 108 at multiplier 102. The product from the multiplier 102 is accumulated and provided to delay line 103, a latch in a preferred embodiment, from which it is transferred to the next tap's summer 104 and then accumulated. The output DTO_E from even delay element 112, a flip-flop in a preferred embodiment, is then sent to an optional re-interleaver (not shown in FIG. 1a) where it is combined with the output DTO_O from the odd delay element 111, a flip-flop in a preferred embodiment, of the parallel circuit handling odd bits along buses 107a and 110 of FIG. 1a for forwarding to a detector (not shown in FIG. 1a). As depicted in FIG. 1a, the latches 103 along buses 107 and 107a are clocked with a logic LOW. The converse occurs along the buses 110 and 110a carrying odd bits in that the latches 103 on buses 110 and 110a are clocked with a logic HIGH.

FIG. 1b depicts a timing sequence used with part of the series of taps for an 5-tap FIR filter, leading to the last tap (associated with c₀). Line 1 of FIG. 1b depicts the bit stream DTI. Line 2 of FIG. 1b shows the 2T clock on which each path 107 and 110 of FIG. 1a of the de-interleaved signal is timed. Line 3 of FIG. 1b shows the even bit stream of path 107 in FIG. 1a to be processed while Line 4 of FIG. 1b shows the odd bit stream of path 110 in FIG. 1a to be processed.

Line 5 of FIG. 1b shows shaded areas at the output of tap 5, during which time a bit stream is most likely being processed. Looking down the slanted lines 112 drawn on this figure provides a view of the “sequential ripple effect” available for borrowing in a preferred embodiment of the present invention. Lines 6 through 10 of FIG. 1b provide timing sequence for the outputs by tap for each tap associated with coefficients 4 through 0. In addition, the slanted shaded areas provide a sense of the “carry propagation” from the LSB to an MSB.

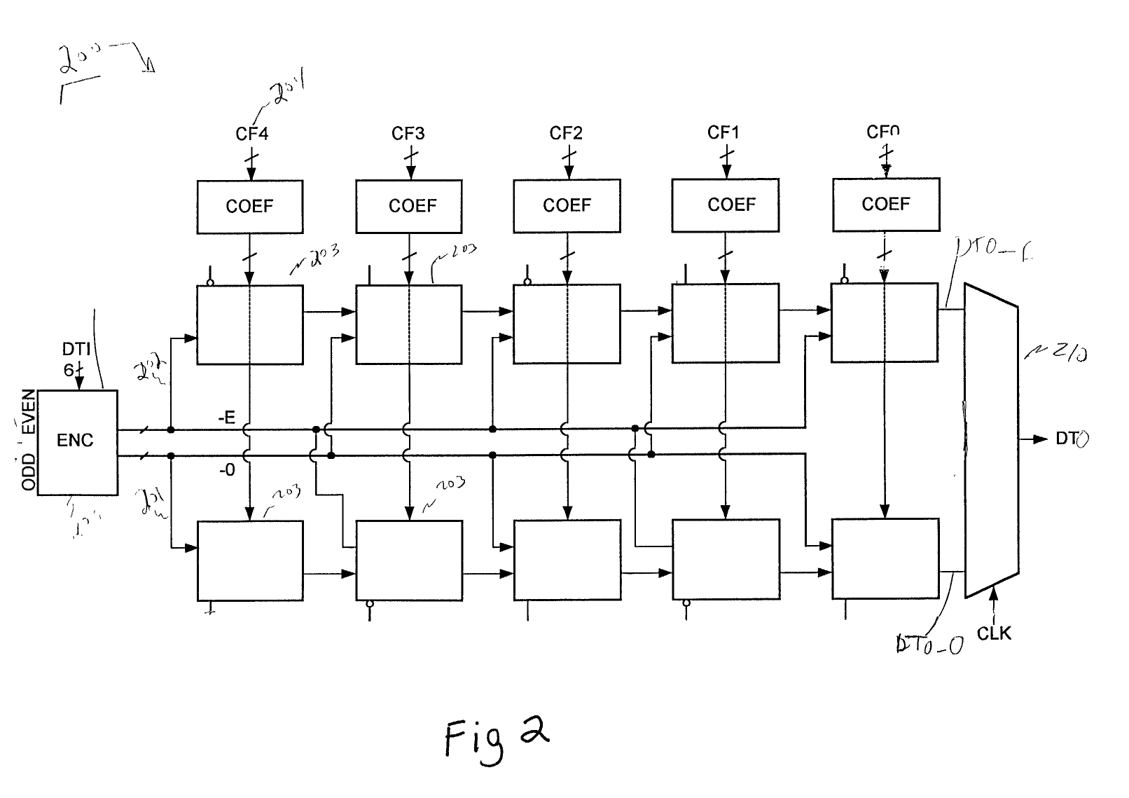

FIG. 2 shows the de-interleaving stage and separate even and odd encoders lumped as 209 for the odd and even bit streams transported on paths 201 and 202, respectively. The filter 200 has five cascaded taps 203. The five taps 203 are associated with coefficients, c₀ through c₄, 204 provided by a coefficient memory (not shown), to be multiplied internally in taps 203. Also shown in FIG. 2 is the optional re-interleaver 210 for combining signals DTO_E and DTO_O, outputs from paths 202 and 201, respectively, into DTO, the output from re-interleaver 210 that is further provided to a detector (not shown).

A preferred embodiment of the present invention uses latches rather than flip-flops at each tap 203, with the possible exception of the last tap 111 and 112 in FIG. 1a of each path (that may use flip-flops instead of latches without performance degradation). The advantage of using latches instead of flip-flops is faster operation, smaller size, and allowed borrowing between taps.

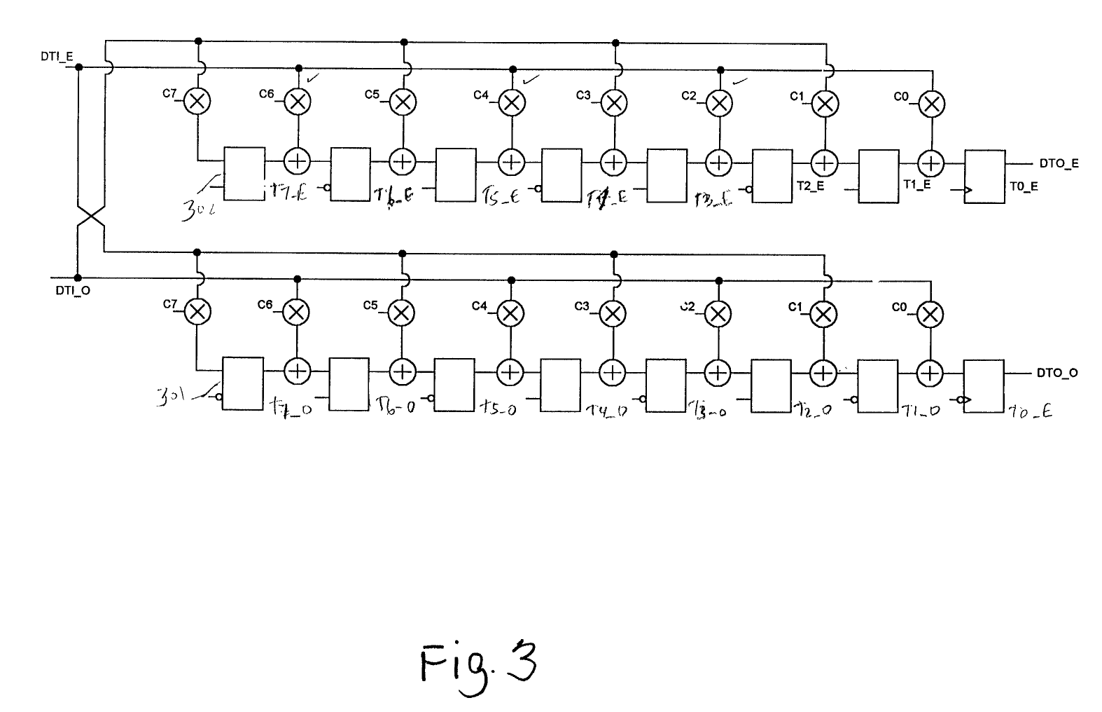

FIG. 3 shows a preferred embodiment of the present invention using an 8-tap FIR filter 300. Note that the first latches 301 and 302 initiate the processing beginning with a different path than that of the odd numbered 5-tap filter of FIG. 1. FIG. 3 also does not show the optional de-interleaving and re-interleaving stages 209 and 210 as shown in FIG.2.

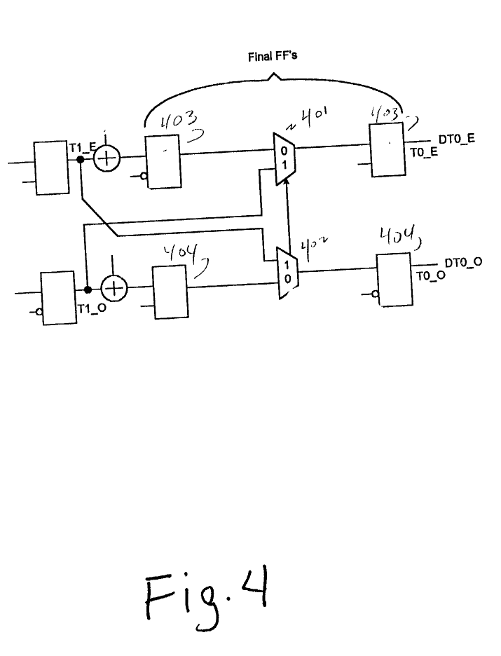

FIG. 4 shows an expanded view of the last tap latching operation prior to output of the separate odd and even bits for an even number of taps (in this case 8) as used with a FIR filter. Note the use of flip-flops 403 and 404 in the final stage and that single flip-flops could be used for latches 403 and 404 if the optional reduction from 8 taps to 6 taps (in this case) is not implemented.

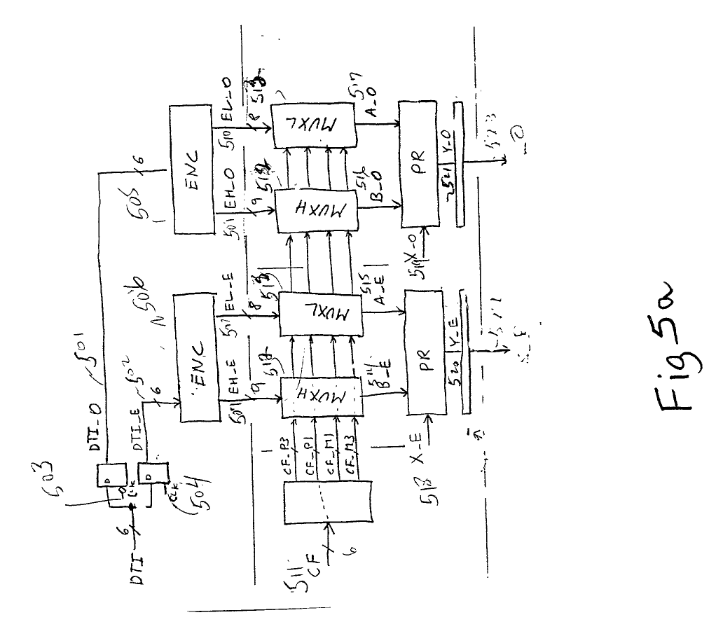

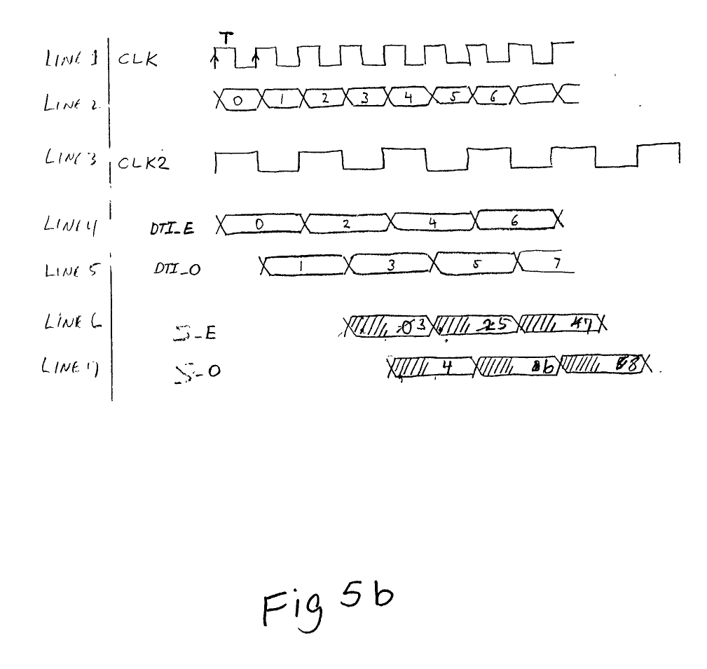

A single tap of a FIR filter is illustrated in FIG. 5a as a summary of actions at each tap of a FIR filter when using a preferred embodiment of the present invention. The odd bits are placed on path 501, latched on logic LOW of the clock as provided on path 503, and the even bits are placed on path 502, clocked on path 504 with a logic HIGH. The odd and even 6-bit signals are then fed to encoders 505 (odd bits) and 506 (even bits), along paths 501 and 502 respectively, for encoding in a high order numbering system such as Radix-8. From each encoder 505 and 506, each signal stream (odd and even bits) is then split into the 9 higher order bits (EH) 507 and 509 and 8 lower order bits (EL) 508 and 510 of the 17-bit encoded signal. From the encoders 505 and 506, the odd and even higher and lower order bit streams 507 through 510 control the multiplexed inputs of the tap's coefficients 511 in pairs of multiplexers 512 and 513, respectively. In turn, these mulitplexed product outputs, B_E 514, A_E 515, B_O 516 and A_O 517 are added together appropriately with the odd and even bit streams of the previous tap values X_E 518 and X_O 519 to form the tap outputs Y_E 520, clocked with a logic LOW, and 521, clocked with a logic HIGH, provided as tap output signal S_E on path 522 and signal S_O on path 523.

FIG. 5b provides yet another picture of timing. Line 1 of FIG. 5b shows the “natural sampling frequency” CLK using square samples of period T. Line 2 of FIG. 5b depicts the input data bit stream signal DTI emerging from an ADC clocked with a period of T. The DTI_E bit stream of line 4 might be sampled by the rising edge of a 2T clock and the other DTI_O line 5 the falling edge of the same 2T clock.

The shaded areas of Line 6 of FIG. 5b, output, S_E, and Line 7 of FIG. 5b, output, S_O, depict an approximation of the time actually needed for processing within the processing period available, 2T, for each tap output Line 6 of FIG. 5b, output, S_E, and Line 7 of FIG. 5b, output, S_O.

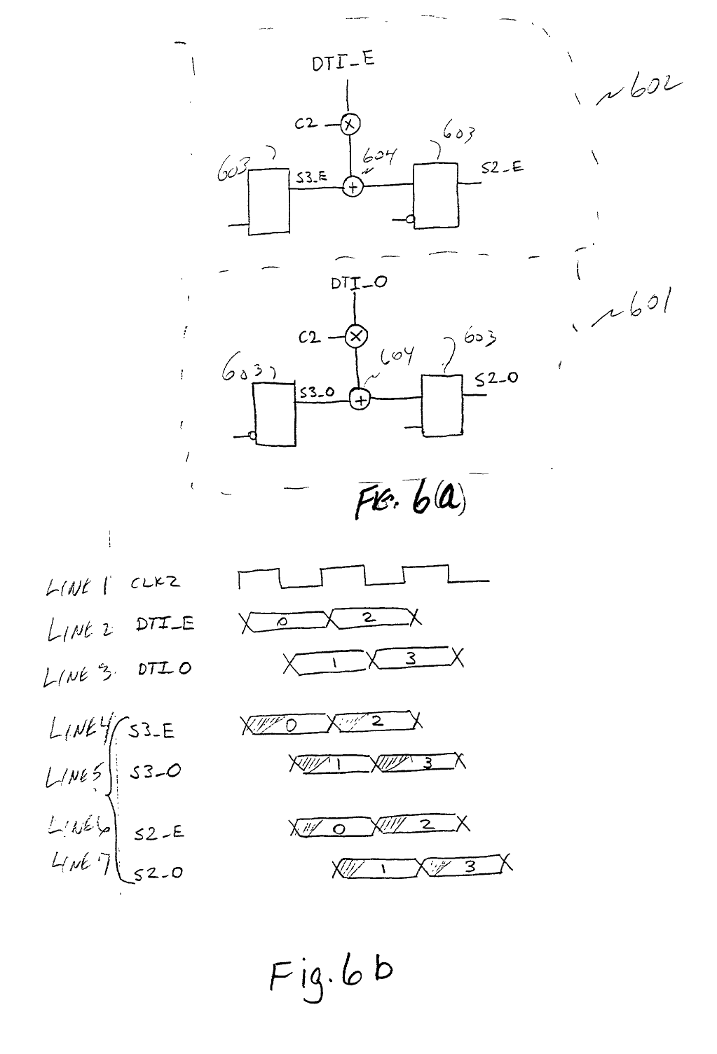

FIG. 6a depicts timing occurrence at a single tap (no. 2, whose coefficient is c₂,) of a 5-tap FIR filter of a preferred embodiment. The portion carrying the odd bit stream 601 is shown paralleling the portion carrying the even bit stream 602. Note that latches are logic configured oppositely for each bit stream 601 and 602.

FIG. 6b shows the timing sequence for the single parallel taps of FIG. 6a. Line 1 of FIG. 6b shows clock period, 2T, for each path. Line 2 of FIG. 6b shows the signal DTI_E along the even bit stream's path 602 in FIG. 6a and Line 3 of FIG. 6b shows the signal DTI_O along the odd bit stream's path 601 in FIG. 6a . Lines 4 and 5 of FIG. 6b provides a comparison of time available for processing with time most likely needed for processing for the signals S3_E and S3_O approaching the summer 604 in each of paths 601 and 602, i.e., the shaded areas. Likewise, Lines 6 and 7 of FIG. 6b provide a comparison of time available for processing with time most likely needed for processing for the signals S2_E and S2_O approaching the summer for the next tap, tap 2 (not shown in FIG. 6a ) in each of paths 601 and 602, i.e., the shaded areas.

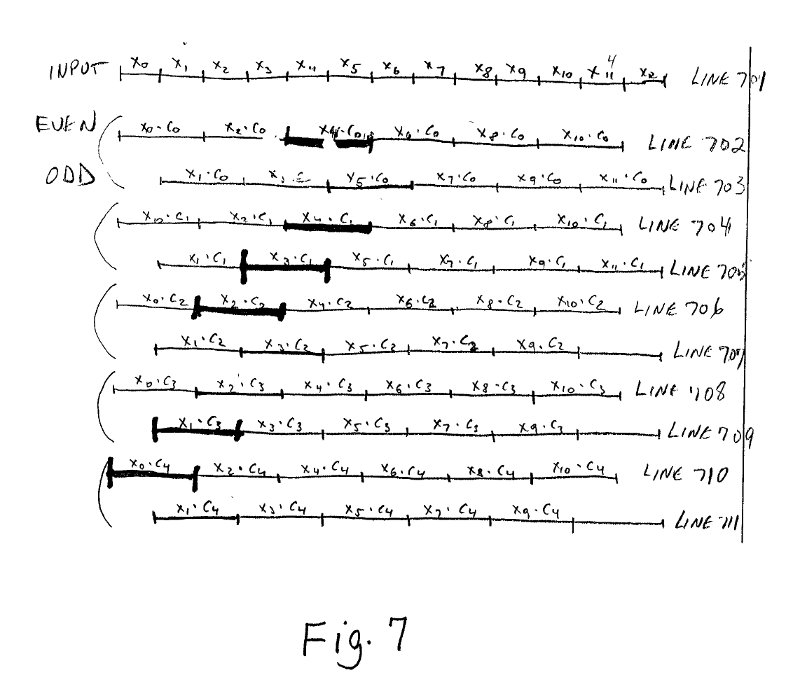

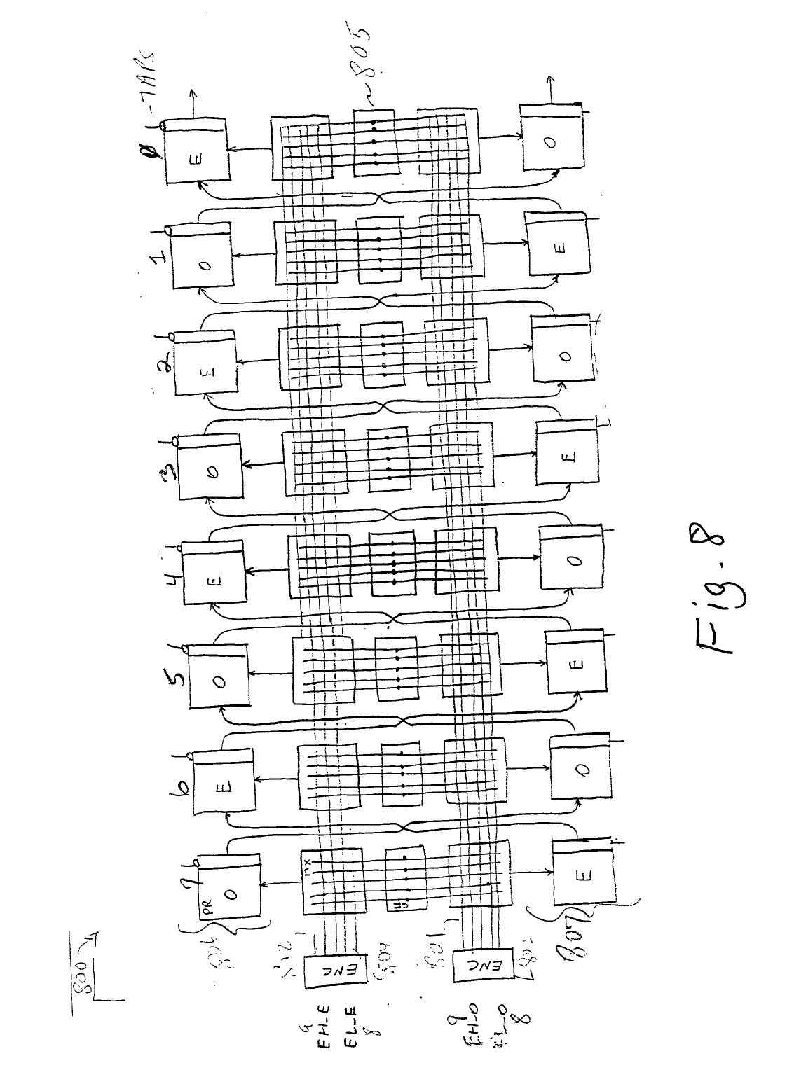

FIG. 7 shows a timing diagram for a 5-tap preferred embodiment of the present invention. For line number 701 of FIG. 7, xᵢ's are the bit sample values at i while the cⱼ's are the coefficient values at tap j, where j=0, 1, 2, 3, 4 for the 5-tap example of FIG. 7.

Now, comparing line 703 of FIG. 7 with line numbers 701 and 702 of FIG. 7, the overlap of processing the x₁c₁ partial product while the x₀c₀ operation is being completed is evident. Even samples (bits) are processed within a clock period of 2T in lines 702, 704, 706, 708, and 710 of FIG. 7, while odd samples (bits) are processed within a clock period of 2T in Lines 703, 705, 707, 709, and 711 of FIG. 7. The overall process, including de-interleaving and re-interleaving, takes little more time than a straightforward single path full “natural sampling rate” processing, while allowing a higher natural data rate (e.g., faster rotation of the disk or higher density on the disk, or both). Further it does not require separate filter or processing sections be added to the silicon area.

The key point to note is that the least significant bit (LSB) can be used as soon as the latch opens at a tap, thus completing “pre-calculation” by the time the MSB arrives from the previous tap. Since there are now available two full “natural sampling rate” clock cycles for multiplication and accumulation of the partial products, less than one full cycle is needed for accumulation with the previous tap. Note line 702 of FIG. 7 compared to the natural sampling rate of samples on line 701 of FIG. 7. There are fully two “natural sampling rate” clock cycles in which to perform the necessary multiplication and accumulation of c₀ times x₀.

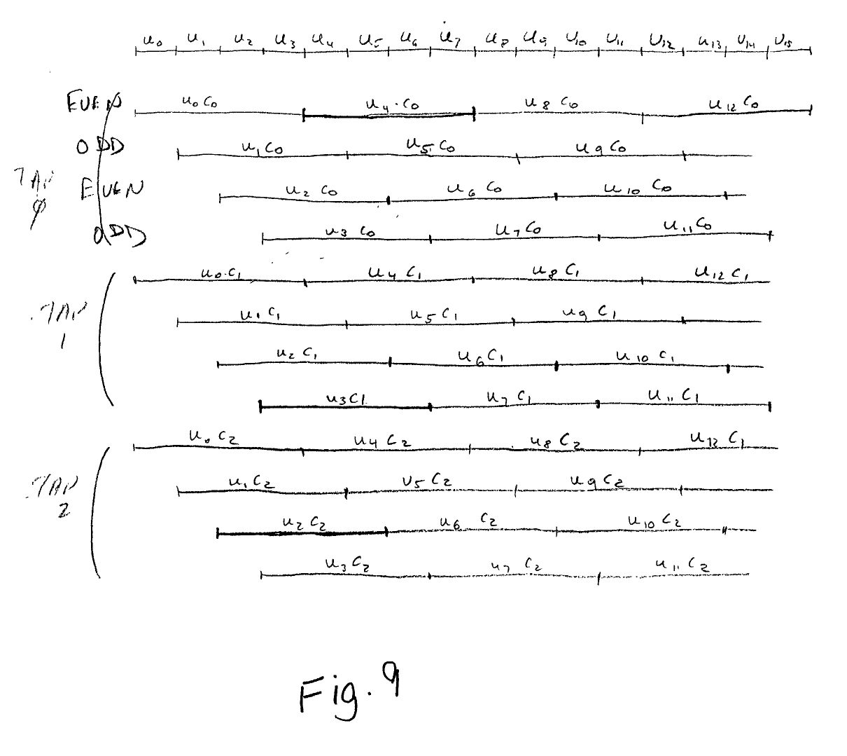

FIG. 8 depicts an advantage of a preferred embodiment of the present invention when laying out integrated circuits (ICs). The preference is for regular and rectangular layouts. This preferred embodiment of the present invention readily lends itself to a rectangular layout. FIG. 8 shows the products accumulating at the 8 taps of an 8-tap FIR filter 800 of a preferred embodiment of the present invention with the encoded data even and odd bit streams 801 and 802, respectively, laid side by side and the encoders 803 and 804, respectively, orthogonal thereto with the coefficient sources 805 running between the two parallel processing paths. The products along the top horizontal half 806 are latched when the clock is logic LOW, while those along the bottom horizontal half 807 are latched when the clock is logic HIGH.

FIG. 9 shows another preferred embodiment of the present invention for a 3-tap FIR so as to illustrate the concept only. A preferred embodiment is not limited to parallelism by a single pair. In FIG. 9, a four-way parallelism can be seen laid out for taps 0, 1, and 2 of FIG. 9, expanding on the concept shown in FIG. 7.

The foregoing describes the salient features of the present invention's parallel structure and modified architecture, and should not be interpreted as limiting the application of, method of operation, or uses for the present invention to that specified in the foregoing. While the invention has been shown with specific components and circuits, and further described with regard to specific number system types, it will be understood by those skilled in the art that various other changes in the selection of components and use with different combinations of circuit components, or other details may be changed without departing from the spirit and scope of the invention.

I claim:

1. An architecture for processing an incoming signal having a natural frequency, comprising:
parallel paths for processing the signal; and
a structure facilitating common processing between said parallel paths,
wherein the processing on each of said paths is done at half the natural frequency of the incoming signal.

2. The architecture of claim 1 wherein said common processing comprises applying odd and even bits of the signal in an alternating pattern on each of said paths.

3. The architecture of claim 1 employing an encoding system higher than Radix-2.

4. The architecture of claim 1 wherein said structure employs latches.

5. The architecture of claim 2 wherein a pair of said parallel paths operate on bit streams of alternating odd and even samples of the signal, respectively
wherein, one set of said alternating samples is latched on logic level HIGH and the other on logic level LOW.

6. The architecture of claim 3 wherein said encoding system is Radix-8.

7. A FIR filter for processing an incoming signal having a natural frequency, comprising:
parallel paths for processing the signal; and
a structure facilitating common processing between said parallel paths,
wherein the processing on each of said paths is done at half the natural frequency of the incoming signal.

8. The filter of claim 7 wherein said common processing comprises applying odd and even bits of the signal in an alternating pattern on each of said paths.

9. The filter of claim 7 employing an encoding system higher than Radix-2.

10. The filter of claim 7 wherein said structure employs latches.

11. The filter of claim 8 wherein a pair of said parallel paths operate on bit streams of alternating odd and even samples of the signal, respectively
wherein, one set of said alternating samples is latched on logic level HIGH and the other on logic level LOW.

12. The filter of claim 9 wherein said encoding system is Radix-8.

13. A system for processing an incoming signal having a natural frequency, comprising:
parallel paths for processing the signal; and
a structure facilitating common processing between said parallel paths,
wherein the processing on each of said paths is done at half the natural frequency of the incoming signal.

14. The system of claim 13 wherein said common processing comprises applying odd and even bits of the signal in an alternating pattern on each of said paths.

15. The system of claim 13 employing an encoding system higher than Radix-2.

16. The system of claim 13 wherein said structure employs latches.

17. The system of claim 14 wherein a pair of said parallel paths operate on bit streams of alternating odd and even samples of the signal, respectively
wherein, one set of said alternating samples is latched on logic level HIGH and the other on logic level LOW.

18. The system of claim 15 wherein said encoding system is Radix-8.

19. The system of claim 13 wherein said system implements a FIR filter.

20. The system of claim 13 wherein said system is a mass data storage system.

21. The system of claim 20 wherein said mass data storage system is a disk drive.

22. A method for processing an incoming signal having a natural frequency, and being encoded in Radix-N, comprising:
deploying parallel paths of operation; and
processing the signal on each path while using operations that are common to each of said paths.

23. The method of claim 22 wherein said common processing comprises applying odd and even bits of the signal in an alternating pattern on each of said paths.

24. The method of claim 22 wherein said processing is done at approximately half the natural frequency of the incoming signal.

25. The method of claim 22 employing an encoding structure higher than Radix-2.

26. The method of claim 23 wherein a pair of said parallel paths operate on bit streams of odd and even samples of the signal, respectively wherein, one set of samples is latched on logic HIGH and the other on logic LOW.

27. The method of claim 25 employing Radix-8 as said encoding structure.

28. A method for processing an incoming signal, encoded in Radix-N, in that a FIR filter having timing critical and less timing critical taps is employed, the filter having an architecture with a structure, the structure including retiming stages incorporating slack time, comprising:
deploying parallel paths of operation; and
processing the signal on each path while using operations that are common to each of said paths.

29. The method of claim 28 wherein said common processing comprises applying odd and even bits of the signal in an alternating pattern on each of said paths.

30. The method of claim 28 wherein said processing is done at approximately half the natural frequency of the incoming signal.

31. The method of claim 28 employing an encoding structure higher than Radix-2.

32. The method of claim 29 wherein a pair of said parallel paths operate on bit streams of odd and even samples of the signal, respectively,
wherein, one set of samples is latched on logic HIGH and the other on logic LOW.

33. The method of claim 31 employing Radix-8 as said encoding structure.
